(19) United States
(12) Patent Application Publication
(10) Pub. No.: US 2005/0177485 A1
(43) Pub. Date: Aug. 11, 2005

(54) Method for rapid and accurate pricing of options and other derivatives

(76) Inventor: William Peter, Bethesda, MD (US)

Correspondence Address: KATTEN MUCHIN ROSENMAN LLP, 525 WEST MONROE STREET, CHICAGO, IL, 60661-3693, US

(21) Appl. No.: 11/052,954

(22) Filed: Feb. 9, 2005

Related U.S. Application Data
(60) Provisional application No. 60/542,329, filed on Feb. 9, 2004.

(51) Int. Cl. G06F 17/60

(52) U.S. Cl. 705/35

(57) ABSTRACT

A method and computer program product are described that allow accurate and extremely fast pricing of financial derivatives, such as options or futures. The method and computer program have accuracy and speed advantages over Monte-Carlo simulations. Other applications of the method include valuations of mortgage-backed securities, exchange rates, and insurance and credit risk valuations.

### CROSS REFERENCE TO RELATED APPLICATIONS

This application claims priority under 35 U.S.C. § 119(e) to Provisional Application No. 60/542,329, entitled “A Method for Rapid and Accurate Pricing of Options and Other Derivatives”, and filed Feb. 9, 2004. The entire contents of Provisional Application No. 60/542,329 are incorporated herein by reference.

### BACKGROUND OF THE INVENTION

1. Field of the Invention

The present invention relates generally to risk-based financial instruments and more particularly to the processing, valuating, and trading of financial instruments such as options and other derivatives and the like.

2. Related Art

Consider the valuation of derivative financial instruments whose underlying assets or rate structures are assumed to move according to a given volatility, so that the behavior is stochastic. These financial instruments include the broad class of options and exotic options based on asset classes such as equities, commodities, and exchange rates. It also includes mortgage-backed securities and other risk-based financial instruments. Pricing of such derivatives can be done by: (1) lattice methods (e.g., binomial trees); (2) finite-difference methods of the relevant partial differential equation obtained by using Itô's Lemma; and (3) Monte-Carlo simulations of the equivalent Itô stochastic differential equation. Monte-Carlo methods are frequently used because:

1. No analytic solution is available for most models.

2. Easy implementation.

3. Able to handle wide range of models (e.g., path-dependence, stochastic volatility models, etc.).

4. Convergence rate is independent of the number of state variables, so derivatives whose value depends on more than one underlying asset can be calculated.

Monte-Carlo simulation has two disadvantages: (1) it has a slow convergence rate so that a large number of paths are required to obtain a sufficiently accurate solution; and (2) being statistical, it suffers from statistical noise. This necessitates artificial methods to rectify the statistical noise (e.g., so-called variance reduction techniques such as “control variates” or “antithetic variates”).

Monte-Carlo methods were first used as a research tool to solve for neutron diffusion in fissile materials, a problem motivated by the development of the atomic bomb at Los Alamos. Later, Ulam and von Neumann provided the formal mathematical foundation for the method, which is now used extensively by physicists and other scientists to solve many difficult problems in physics, biology, finance, etc. For example, the so-called Fokker-Planck equation, which in one-dimension has the form:

$$\frac{\partial f ( x , t )}{\partial t} = - \frac{\partial }{\partial x} [ A ( x , t ) f ( x , t ) ] + \frac{1}{2} \frac{{\partial }^{2}}{\partial {x}^{2}} [ B ( x , t ) f ( x , t ) ] \qquad ( 1 )$$

describes the probability density f=f(x,t), or the conditional probability density f=f(x, t|x₀, t₀), of an ensemble of particles with initial position x₀ at the initial time t₀. Equation (1) is also equivalent to the one-dimensional Itô stochastic differential equation:
dx(t)=A[x(t),t)]dt+\sqrt{B[x(t)t]}dW(t) (2)
where dW(t) represents a Weiner process [1-3]. The quantity A(x,t) is known as the drift vector and B(x,t) is known as the diffusion matrix.

The Fokker-Planck equation shown above is a drift-diffusion equation and describes many fundamental processes in physics, including plasma flow, fluid dynamics, diffusion processes, etc. For example, the one-dimensional diffusion equation for a given mass function f(x, t) can be written:

$$\frac{\partial f}{\partial t} = D \frac{{\partial }^{2} f}{\partial {x}^{2}} \qquad ( 3 )$$

This corresponds to the Fokker-Planck equation with A=0 and B=1, and is formally equivalent to the Itô stochastic differential equation:
x(t+dt)=x(t)+\sqrt{2Ddt} N(0,1) (4)
governing a Weiner process. Equation (4) is essentially the integral of Equation (3) by a system of independent walkers, each taking a different path from t to t+dt. The probability that a particle initially at the position x₀=x(t=0) arrives at x=x(t) is then described by:
x=x₀+\sqrt{2Dt} N(0,1) (5)
or
x(t)=N(x₀,2Dt) (6)

As pointed out by Albright et al., the normal distribution N(x₀, 2Dt) in Equation (6) can be described as the Green's function, or propagator:

$$G ( x , t \vert {x}_{0} , 0 ) = \frac{1}{\sqrt{2 π Dt}} exp [ \frac{- {( x - {x}_{0} )}^{2}}{2 Dt} ] \qquad ( 7 )$$

and the solution to Equation (3) can be written formally as:

$$f ( x , t ) = {\int }_{- ∞}^{∞} ⅆ {x}_{0} f ( {x}_{0} , 0 ) G ( x , t \vert {x}_{0} , 0 ) \qquad ( 8 )$$

The integral off(x₀, 0) over the Green's function defined by Eq. (7) can be interpreted as an integral over the normal probability density function. The quantity f(x,t) in Eq. (8) is then taken to be the expectation value off(x₀, 0) at time t. If N sample paths are taken, f(x, t) is

$$f ( x , t ) = {\sum }_{j = 1}^{J} \frac{f ( {x}_{j} )}{N} \qquad ( 9 )$$

where xⱼ=x₀+√(2Dt) zⱼ, and the zⱼ are samples drawn from the random variable N(0, 1). This Monte-Carlo integration of Eq. (3) is statistically noisy, and converges slowly as 1/N, thus requiring a very large number N of paths. Typically, thousands of paths are needed, and when great accuracy is required, N might be required to be of the order of 10⁴. Of course, the larger N is chosen to be, the slower the calculation.

Statistical noise produced when generating a series of pseudo-random numbers for Monte-Carlo methods has motivated financial engineers to develop so-called “variance reduction techniques”. These artificial techniques are used to mitigate the statistical noise and reduce the large number of required sample paths. For example, one such approach, the use of so-called “control variates”, is very problem-specific and relies on a priori knowledge of a solution to a similar problem. None of these variance reduction techniques is completely effective.

Therefore, given the foregoing, the present inventor has recognized a need for a method and computer program product that provides more accurate and faster pricing of financial derivatives than Monte-Carlo simulations. Such a method and computer program product should be able to quickly and accurately price complicated hedging strategies or exotic options, as well as simple derivatives, such as vanilla options.

Each of the following references is hereby incorporated by reference in its entirety: (1) John C. Hull, Options, Futures, & Other Derivatives, Prentice Hall, Upper Saddle River, N.J., 4^{th} Edition, 2000; (2) C. W. Gardiner, Handbook of Stochastic Methods, 2^{nd} Ed. (Springer, New York, 1985); (3) D. S. Lemons, An Introduction to Stochastic Processes in Physics (Johns Hopkins, Baltimore, 2001); (4) K. Itô and H. P. McKean Jr., Diffusion Processes and their Sample Paths (Springer, Berlin, 1974); (5) B. J. Albright, W. Daughton, D. S. Lemons, D. Winske, and M. E. Jones, Physics of Plasmas 9, 1898 (2002); (6) B. J. Albright et al., Phys. Rev. E. 65, 055302/1-4 (2002); (7) M. H. Kalos and P. A. Whitlock, Monte-Carlo methods, Vol. I (John Wiley & Sons, New York, 1986), p.90; (8) W. H. Press, S. A. Teukolsky, W. T. Vetterling and B. P. Flannery, Numerical Recipes in C: The Art of Scientific Computing, 2^{nd} Ed. (Cambridge University Press, Cambridge, 1992); (9) A. L. Garcia, Numerical Methods for Physics, 2^{nd} Edition (Prentice-Hall, Upper Saddle River, N.J., 2000); (10) M. Abramowitz and I. Stegun, Handbook of Mathematical Functions (Dover, New York, 1972).

### SUMMARY OF INVENTION

The present invention meets the above-identified needs by providing a method and computer program product for rapid and accurate pricing of options and other derivatives.

In a preferred embodiment, a method and computer program product calculates financial derivatives, such as, for example, options, futures, mortgage-backed securities and the like, based on deterministic sampling instead of random sampling. The deterministic sampling is implemented by preserving the moments of the random variable associated with the stochastic process up to a given order.

One advantage of the present invention over Monte-Carlo methods is the lack of statistical noise. Hence, a calculation using the present invention is more accurate than Monte-Carlo. Also, artificial methods presently used to rectify the statistical noise in Monte-Carlo (e.g., so-called variance reduction techniques such as “control variates” or “antithetic variates”) are not required when using the present invention to price financial derivatives.

Another advantage of the present invention is that the number of required paths for obtaining an accurate solution is several orders of magnitude less than the analogous number of paths required by the Monte-Carlo method. Because the number of paths that is required for a calculation relates to computational speed, the present invention typically operates thousands of times faster than a Monte-Carlo simulation of the same scenario.

### BRIEF DESCRIPTION OF THE DRAWINGS

FIG. 1 is a flow chart of an embodiment of the present invention that prices a European call option.

FIG. 2 is a flow chart of an example Monte-Carlo simulation that determines the price of a European call option.

FIG. 3 is a schematic drawing of generating 12 paths by the deterministic sampling method of this invention. Each path advances in time by Equation (17) and is characterized by a deterministic sample (both abscissa and weight). At the final time, the final path positions are averaged by their respective weights to find the final expected value of the underlying financial asset or rate structure.

FIG. 4 is a plot of comparing the Vasicek term structure model results using Monte-Carlo simulation (black dots), the present invention (white dots), and the exact analytic solution to the specific term structure model given by Equation (18) (solid line). The results of the present invention are “right on” the exact values, while Monte-Carlo results oscillate about the exact solution with large percentage error.

FIG. 5 is a schematic drawing of an example of an exemplary computer system.

### DETAILED DESCRIPTION OF THE INVENTION

Many financial derivatives are based on underlying assets that behave stochastically in time. For example, the price of an equity asset is usually assumed to follow geometrical Brownian motion, and can be represented as:
Sₖ(T)=S(0)exp[(r−σ²/2)T+σ\sqrt{T} N(0,1)]. (10)
This equation describes the evolution of an asset price S(0) from a time t=0 to a time t=T where σ is the volatility and r is the riskless rate of return.

Pricing of derivatives, such as stock options, that depend on an underlying asset evolving according to Equation (10) involves finding the expected value of the payoff. This expected value is calculated by advancing in time a large number of possible paths the underlying security (i.e., the price of the asset) may take from t=0 (i.e., the starting price of the asset) to t=T (i.e., a later price of the asset at time T). When using Monte-Carlo calculation, this is done by finding a set of realizations of the normal random variable N(0, 1), which defines a set of possible paths for the asset. The price of the derivative, being a function of the price of the underlying asset price, is then calculated. Based on this expected value of the asset at a later time T (e.g., the option expiration date), the current price of the derivative can be determined.

For example, assume a stock behaves according to Equation (10), and assume that one is interested in purchasing a European call option on the stock. How does one conventionally calculate the present value of the call option? The price c_{T} of such a European call option is the discounted value of its expected future value, as determined by the following equation:
c_{T}=e^{-rT} E[(S_{T}−K)⁺] (11)
where K is the option strike price, and (S_{T}−K)⁺=max{S_{T}−K, 0}. The expected value from a Monte-Carlo simulation is obtained by taking a large number N of possible paths to advance the stock price. Each path is obtained from Equation (10) by realizing the random variable N(0, 1) by a suitable algorithm (e.g., the Box-Muller algorithm). Each of these pseudo-random values, when substituted into Equation (10), gives a value for the stock price S(T) at a time T. The payoff of the option for a specific path at maturity T is given by
max(S_{T}−k)≡(S_{T}−K)⁺ (12)
Given a large number of paths j, the expectation value E of these payoffs is just the simple arithmetic average. Formally, this may be written as follows:

$$E [ {( {S}_{T} - K )}^{+} ] = \frac{1}{N} {\sum }_{j = 1}^{N} [ {( {S}_{j} - K )}^{+} ] \qquad ( 13 )$$

and the call option price c_{T} is then found from Equation (11).

Monte-Carlo simulation requires a large number of walkers to “sample” the probability distribution function of the random variable. The integration scheme is low-order, and is somewhat equivalent to using the trapezoidal rule—where all nodes are random and all weights are equal—to approximate the integral of a function. The present invention uses a deterministic sampling method that prices financial derivatives by preserving the moments of the random variable up to a given order. This approach is analogous to using Gaussian quadrature instead of the simple trapezoidal rule for integration. If ρ(x) is a given weight function, Gaussian integration of a function f(x) is defined by:

$${\int }_{- ∞}^{∞} ⅆ x ρ ( x ) f ( x ) = {\sum }_{j = 1}^{J} {w}_{j} f ( {q}_{j} ) \qquad ( 14 )$$

for a given set of abscissas qⱼ and weights wⱼ. Note that this formula is exact when the function f(x) is a linear combination of the 2J-1 polynomials x⁰, x¹, . . . , x^{2J-1}. Hence, if f(x) is the set of 2J−1 polynomials x⁰,x¹, . . . , x^{2J-1}, Equation (14) finds the moments of the weight function ρ(x) up to the (2J−1)-th order.

The weight function ρ(x) is identified as a propagator, G(x,t|x₀,t₀), which propagates the asset price from t=t to t=t+dt (see Equation (8)). Each of the J pairs of abscissas qⱼ and weights wⱼ (j=1 to J) corresponds to a unique path taken by the propagator. The asset price still behaves stochastically, but the paths are deterministically generated by the probability distribution function of the random variable itself. In addition, each path has an associated “weight” or importance based on the properties of the particular probability distribution function. For example, for a simple diffusion process as described by Equation (3), the update becomes:
x(t+dt)=x(t)+\sqrt{2Ddt}qᵢ (15)

As shown in Equation (15), each realization of the random variable N(0,1) in Equation (4) is replaced by an abscissa qⱼ determined from Equation (14). In one embodiment of the present invention, the total number of paths is not required to be more than twelve for excellent numerical accuracy. For N=12 there are twelve pairs of abscissas qⱼ and weights wⱼ that must be calculated from Equation (14).

Note that the weight wⱼ of each path must be included in any kind of statistical averaging. In contrast to the expected payoff of a European call option by Monte-Carlo simulations as shown in Equation (11), the corresponding expression according to an embodiment of the present invention is written:

$$E [ {( {S}_{T} - K )}^{+} ] = {\sum }_{k = 1}^{N} \frac{{w}_{k}}{{\sum }_{j} {w}_{j}} [ {( {S}_{k} - K )}^{+} ] \qquad ( 16 )$$

and the value of the option is just the discounted value of its expected future value at maturity T, and is given by substituting Eq. (16) into Eq. (11).

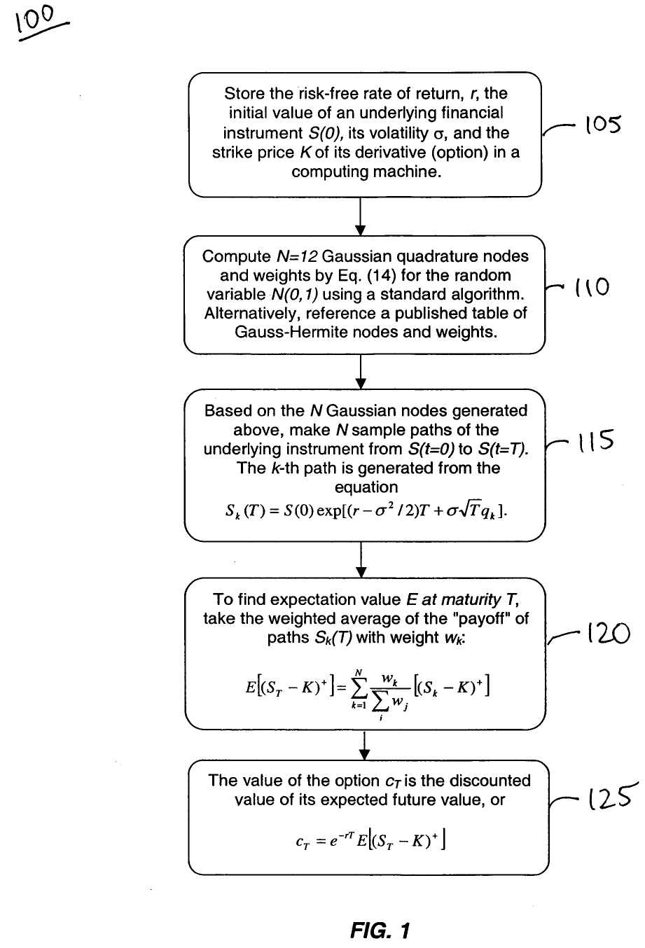

In the present invention, pricing financial derivatives is accomplished by evolving the underlying asset by means of deterministic sampling. Referring to FIG. 1, in implementing this method, according to one embodiment 100 for the European call option as described above, the following steps are performed:

1. In step 105, in the volatility term to the stochastic differential equation governing the underlying asset, identifying the term(s) with a random variable.

2. In step 110, calculating the first 2N moments of this random variable, starting with the zeroth moment and ending with the 2N−1-th moment, where N is a given number. The more moments (the larger N) that are calculated, the higher order (i.e., more exact) the integration.

3. Also in step 110, the N terms for the weight wᵢ and abscissa qᵢ corresponding to these moments are then calculated from Equation (14).

4. In step 115, a series of N paths can then be used to evolve the price of the underlying asset. Each path is generated by advancing the asset price S(t) in time from its stochastic differential equation, with each of the abscissas qⱼ replacing a realization of the random variable. For example, compare Equation (15) with Equation (4).

5. In step 120, to find the expected payoff at maturity T, the averaging of each path takes into account the associated path weight using Equation (15).

6. In step 125, the value of the derivative (or option) is the discounted value of its future expected payoff at maturity T. Hence, the value of the derivative is obtained by multiplying the expected payoff at maturity, E└(S_{T}−K)⁺┐, by e^{-rT} where r is the risk-free rate of return.

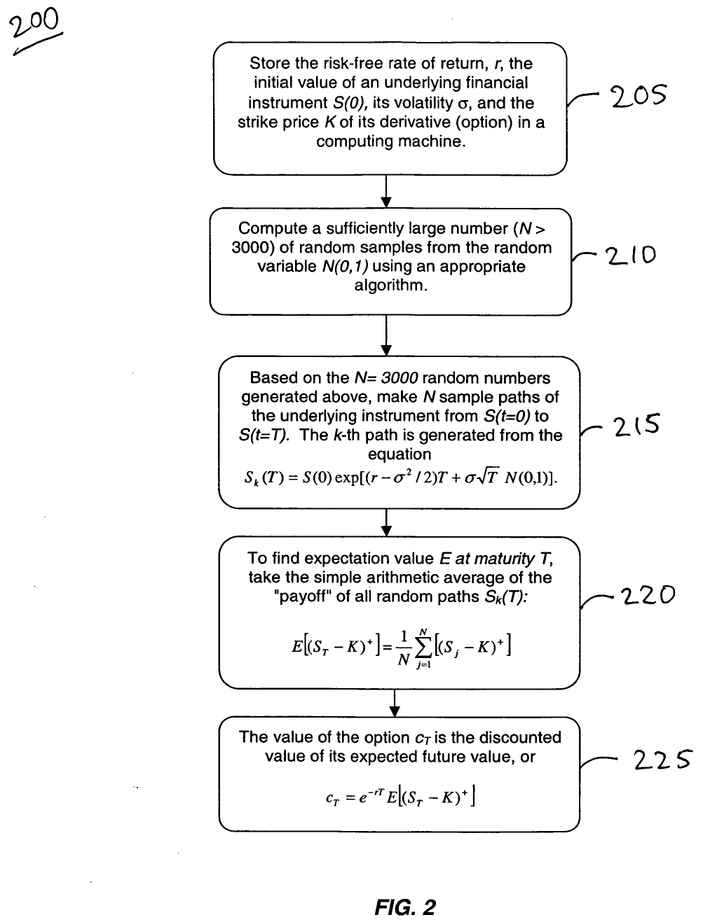

The methodology detailed in items (1-6) above is shown in terms of a flowchart in FIG. 1. For comparison, the methodology for an equivalent Monte-Carlo simulation is shown in FIG. 2. It is also noted that the methodology of the present invention may be applied to the valuation of a derivative financial instrument that is related to more than one volatile asset, the behavior of each of which is stochastic, by defining a set of stochastic differential equations, each of which governs the values of a respective volatile asset, and by using starting prices for each volatile asset to determine corresponding later prices of each asset. In this manner, the derivative pricing methodology of the present invention is said to be multidimensional, as it can be applied to a derivative that relates to one or more underlying assets.

The present invention is now described in more detail below in terms of an exemplary embodiment to calculate the Term Structure of Interest Rates. As in the previous section where the European call option was described, this specific example is discussed for convenience only, and is not intended to limit the application of the present invention. In fact, after reading the following description, it will be apparent to those skilled in the relevant art(s) how to implement the following invention in alternative embodiments, e.g., other types of options and other derivatives, including path-dependent options and commodity-based futures.

In particular, the one-factor model of Vasicek is now considered, in which all rates depend on the shortest-term interest rate, or the spot rate. If r(t) is the spot rate at a time t, then the rate at a later time t+dt is given by
r(t+dt)=r(t)+α(γ−r(t))dt+σZdt (17)
where Z is the normal random variable N(0, 1). In this equation, γ is the long-term mean spot interest rate, α>0 is the “pressure” to revert to the mean, and σ is the instantaneous square root of the variance. Unlike stock price models that are multiplicative (e.g., the European call option discussed above), term structure models are additive. This particular example of the Vasicek model is included to show the applicability of the present invention to a variety of risk-based financial instruments. The Vasicek model is useful, for instance, in determining the value of interest-rate sensitive instruments such as bonds.

As a specific example, an initial interest rate of 3% is assumed, and the parameters α=0.04, γ=0.1, σ=0. 12, and a timestep dt=0.0001 are used, and this simulation is run for a series of 3000 steps. The explicit steps to pricing the Vasicek model using an embodiment of the present invention are:

1. As discussed above, substitute the parameters α=0.04, γ=0.1, σ=0.12, and r=0.03 into Equation (17). Note the volatility term contains the normal random variable Z=N(0, 1).

2. To calculate the expectation value of the rate at the time T, as an example, N=12 paths are used. It is then required to calculate the first 2N=24 moments (including the zeroth moment through the 2N−1=23rd moment) of the normal random variable in Equation (16), where N=12. The more moments (i.e., the larger N), the more exact the integration will be.

3. The N terms for the weight wᵢ and abscissa qᵢ corresponding to this particular random variable are then calculated using Equation (14). Note that in another embodiment, it would not be necessary to evaluate these quantities each time the method is executed. These quantities can be calculated once, stored on a hard disk, flash memory, or other media, and then used at a later date. If a different number of paths is desired, or the stochasticity of the asset changes (so that the random variable changes), the set of pairs (qᵢ, wᵢ) need to be re-evaluated. In an alternative embodiment, these pairs can be looked up in a mathematical table. For example, for a normal random variable, the pairs (qᵢ, wᵢ) are known as Gauss-Hermite parameters, which have been tabulated.

4. The interest rate r(t) is evolved by generating N paths (in this example, N=12 has been chosen) according to Equation (17). Each path rⱼ(t), corresponding to a specific node qᵢ with weight wⱼ, is advanced from its initial value at r(t=0)=3% to a new value rⱼ(t) at each time step dt. Eventually each path is advanced by Equation (17) to its maturity at t=T.

5. At maturity t=T, the expected interest rate is obtained by a weighted average of the different paths. The expected interest rate at maturity t=T is then given by:

$$E [ r ( t = T ) ] = {\sum }_{k = 1}^{N} \frac{{w}_{k}}{{\sum }_{j} {w}_{j}} {r}_{k} ( t = T ) \qquad ( 17 )$$

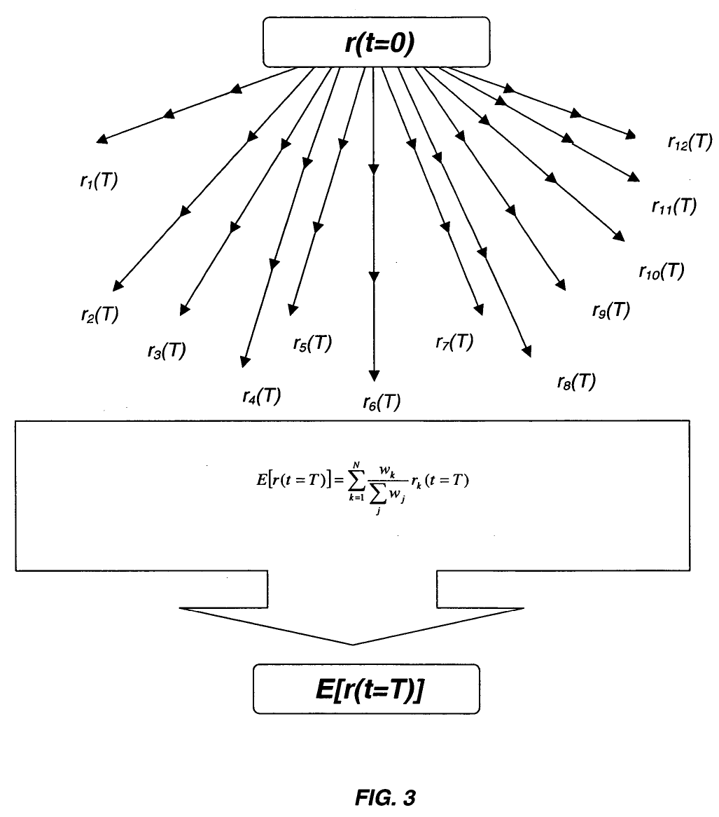

A schematic of this procedure for generating N paths and taking the weighted average to obtain the expected interest rate in the Vasicek model is shown in FIG. 3. In the schematic, a maturity of three time steps is assumed for simplicity.

The simulation results from Equation (17) can be compared with the exact value for the expected interest rate given in the financial literature as
Eₜ[r(T)]=γ+(r(t)−γ)exp[−α(T−t)]. (18)

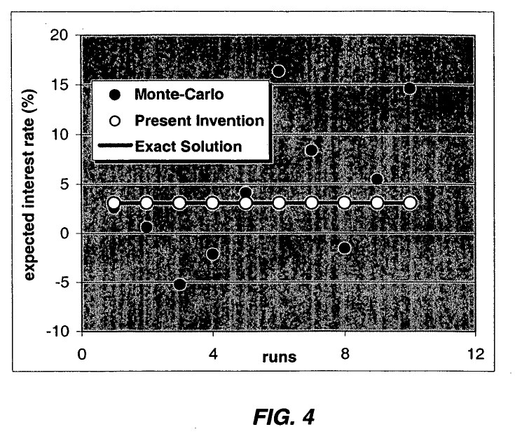

For the values of α, γ, dt, and T given above, the exact solution in Equation (18) yields Eₜ[r(t)]=3.0835%. In Table 1 below, the percentage error relative to this exact value Eₜ[r(t)] from ten Monte-Carlo simulations is computed using random sampling, and the results from ten simulations of the present invention are computed using deterministic sampling. Referring to FIG. 4, the Monte-Carlo results are widely dispersed around the exact value, while the present invention yields results that precisely match the exact value. As shown in Table 1, the average result of the ten Monte-Carlo runs (4.3149%, or 0.043149) had a percentage error of approximately 40%, while the result from the present invention (3.0835%, or 0.030835) had a zero percent error. The average time of the simulations using the present invention was 4 milliseconds, while the average Monte-Carlo simulation took 3449 milliseconds (3.45 seconds). Thus, the simulations from the present invention were not only more accurate but also approximately 863 times faster than the Monte-Carlo simulations.

TABLE 1

| | Expected Rate | | Average Run |
|---|---|---|---|
| Method | (%) | % error | Time (millisecs) |
| 10 Monte-Carlo | 4.3149 | 40% | 3449 |
| Simulations (3000 paths) | (average of all | (based on | (average run time |
| | 10 runs) | average) | of a simulation) |
| Embodiment of Present | 3.0835 | 0% | 4 |
| Invention (12 paths) | | | |

Simulation run-times were obtained on a computer with an Athlon XP 2100 processor running at 1.726 GHz, and with 512 MB of RAM. The simulation codes were written in C++ and compiled with the GNU g++ compiler; run times were determined from the GNU/Linux system utility time.

The present invention, or any part or function thereof, may be implemented using hardware, software or a combination thereof and may be implemented in one or more computer systems or other processing systems. However, the manipulations performed by the present invention are often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

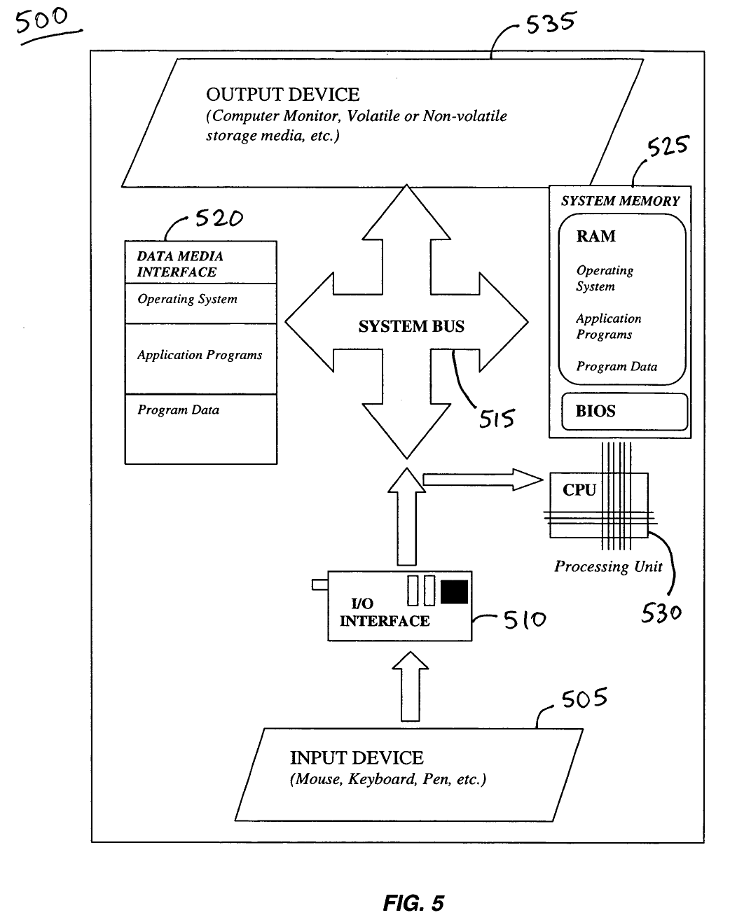

In fact, in one embodiment, the invention is directed toward one or more computer systems capable of carrying out the functionality described herein. Referring to FIG. 5, an example of a suitable computer system 500 within which the invention may be implemented, either fully or partially, is illustrated. This computer system or environment that may be utilized is described herein.

The exemplary computing environment is only one example of a computing environment and does not suggest any limitation as to the scope of use. Neither should the exemplary computing environment be interpreted as having any dependency or requirement relating to any one or combination of components illustrated in the exemplary computing environment.

The framework of the present invention may be implemented with numerous other general or specific computing environments or configurations. Examples may include, but are not limited to, personal computers, server computers, mainframe computers, distributed processing computers, microprocessor-based systems, handheld computers, cellular telephones, and other communication/computing devices.

An exemplary computer system 500 includes one or more processors 530 connected to a communication infrastructure, e.g., a communications bus 515, cross-over bar, or network. Various software embodiments are described in terms of this exemplary computer system. After reading this description, it will become apparent to a person skilled in the relevant art(s) how to implement the invention using other computer systems and/or architectures.

The exemplary computer system can include a display interface 510 that forwards graphics, text, and other data from the communication infrastructure (or from a frame buffer not shown) for display on the display unit.

The exemplary computer system may also include a main memory 525, preferably random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known conventional manner. The removable storage unit represents a floppy disk, magnetic tape, optical disk, etc., which is read by and written to by removable storage drive. As will be appreciated by those of skill in the art, the removable storage unit includes a computer usable storage medium having stored therein computer software and/or data.

In alternative embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read-only memory (EPROM), or programmable read-only memory (PROM)) and associated socket, and other removable storage units and interfaces, which allow software and data to be transferred from the removable storage unit to computer system.

The computer system may also include a communications interface 520. A communications interface allows software and data to be transferred between computer system and external devices 535. Examples of a communications interface may include a modem, a network interface (such as an Ethernet card), a communications port, a Personal Computer Memory Card International Association (PCMCIA) slot and card, etc. Software and data transferred via the communications interface are in the form of signals that may be electronic, electromagnetic, optical or other signals capable of being received by a communications interface. These signals are provided to the communications interface via a communications path, or channel. This channel carries signals and may be implemented using wire or cable, fiber optics, a telephone line, a cellular link, an radio frequency (RF) link and other communications channels.

The terms “computer program medium” and “computer usable medium” are used herein to generally refer to media such as removable storage drive, a hard disk installed in hard disk drive, and signals. These computer program products provide software to the exemplary computer system. The present invention is directed to such computer program products.

Computer programs (also referred to as computer control logic) are stored in main memory 525 and/or secondary memory. Computer programs may also be received via communications interface 520. Such computer programs, when executed, enable the computer system to perform the features of the present invention, as discussed herein. In particular, the computer programs, when executed, enable the processor 530 to perform the features of the present invention. Accordingly, such computer programs represent controllers of the computer system.

In an embodiment where the invention is implemented using software, the software may be stored in a computer program product and loaded into the exemplary computer system using the removable storage drive, the hard drive or the communications interface. The control logic (software), when executed by the processor, causes the processor to perform the functions of the invention as described herein.

A user of the computer system can enter commands and other information into the computer by means of input devices 505 such as paper tape, punch card, keyboard, pen, mouse, or other pointing device. Other input devices are game pads, joysticks, and microphones. These input devices are connected to the computer processing unit 530 by means of an input/output interface that is usually connected to the system bus 515, but can be connected to any other interface or bus structure, such as a Universal Serial Bus (USB), parallel port, or game port.

In another embodiment, the invention is implemented primarily in computer hardware using, for example, hardware components such as logic gates, memory registers, central processing units, and application specific integrated circuits (ASICs). Implementation of the hardware state machine so as to perform the functions described herein will be apparent to persons skilled in the relevant art(s).

In yet another embodiment, the invention is implemented using a combination of both hardware, software, and/or firmware.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention.

For example, it will be apparent to persons skilled in the relevant art(s) after reading the description herein that the methodology of the present invention may be used to quickly and accurately price derivatives based on underlying assets that behave stochastically. Such derivatives may be dependent on one or more state variables: Options—European options, Asian options, Barrier options, Margrabe exchange options, Basket options, Rainbow options, Mountain-Range Options; Fixed-Income Derivatives—Term Structure of Interest Rate Models; Bonds—both coupon bonds and pure-discount (zero-coupon) bonds, and Mortgage-backed securities; Futures—Stock Index Futures and Currency Futures; and Risk Metrics—Insurance Risk Calculations and Credit Risk Calculations. Exemplary underlying assets may include a stock price, an interest rate, a composite credit profile, or a composite insurance profile. Thus, the present invention should not be limited by any of the above-described exemplary embodiments.

In addition, it should be understood that the figures illustrated in the attachments, which highlight the functionality and advantages of the present invention, are presented for example purposes only. The architecture of the present invention is sufficiently flexible and configurable, such that it may be utilized in ways other than that shown in the accompanying figure.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method for pricing a financial derivative, the derivative relating to an asset, the method comprising the steps of:
defining a stochastic differential equation that governs a value of the asset;
identifying a volatility term of the defined equation using a random variable;
calculating 2N moments of the random variable, including a zeroth moment, wherein N is a predetermined natural number;
calculating N pairs of a weight and an abscissa, each weight-abscissa pair corresponding to a calculated pair of moments;
using the weight-abscissa pairs, a starting price of the asset, and the defined stochastic differential equation to define a series of N paths, wherein each path corresponds to one weight-abscissa pair, and each path can be used to determine a corresponding later price of the asset;
performing a weighted averaging of the determined later prices using the corresponding weights to determine an expected payoff value; and
using the expected payoff value to price the derivative.

2. The method of claim 1, wherein the random variable has a normal probability distribution function, and wherein the calculated weight-abscissa pairs correspond to Gauss-Hermite parameters.

3. The method of claim 1, wherein the derivative is selected from the group consisting of a stock option, a bond, a future, a mortgage-backed security, a credit risk calculation, and an insurance risk calculation.

4. The method of claim 1, wherein the asset is selected from the group consisting of a stock price, an interest rate, a composite credit profile, and a composite insurance profile.

5. The method of claim 1, wherein N is less than or equal to 12.

6. A method of doing business using the method of claim 1, further comprising the step of providing data relating to an accuracy of a result of the step of using the expected payoff value to price the derivative.

7. A method of doing business using the method of claim 1, further comprising the step of providing data relating to a computation time for completion of the steps of the method of claim 1.

8. A method of doing business using the method of claim 1, further comprising the step of providing data relating to a comparative accuracy of a result of a Monte Carlo simulation designed to price the derivative.

9. A method of doing business using the method of claim 1, further comprising the step of providing data relating to a comparative computation time for completion of a Monte Carlo simulation designed to price the derivative.

10. A system for pricing a financial derivative, the derivative relating to an asset, and the system comprising:
a communications bus;
a memory module configured to store parameters relating to a stochastic differential equation that governs a value of the asset, a starting price of the asset, and a random variable that identifies a volatility term of the stochastic differential equation;
a processor, the processor being coupled to the memory module via the communications bus; and
an output device, the output device being coupled to the memory module and the processor via the communications bus,
wherein the processor is configured to:
calculate 2N moments of the random variable, including a zeroth moment, wherein N is a predetermined natural number;
calculate N pairs of a weight and an abscissa, each weight-abscissa pair corresponding to a calculated pair of moments;
use the weight-abscissa pairs, the starting price of the asset, and the stochastic differential equation to define a series of N paths, wherein each path corresponds to one weight-abscissa pair, and each path can be used to determine a corresponding later price of the asset;
perform a weighted averaging of the determined later prices using the corresponding weights to determine an expected payoff value; and
use the expected payoff value to price the derivative, and
wherein the output device is configured to receive a result of pricing the derivative and to output the result.

11. The system of claim 10, wherein the random variable has a normal probability distribution function, and wherein the calculated weight-abscissa pairs correspond to Gauss-Hermite parameters.

12. The system of claim 10, wherein the derivative is selected from the group consisting of a stock option, a bond, a future, a mortgage-backed security, a credit risk calculation, and an insurance risk calculation.

13. The system of claim 10, wherein the asset is selected from the group consisting of a stock price, an interest rate, a composite credit profile, and a composite insurance profile.

14. The system of claim 10, wherein N is less than or equal to 12.

15. An apparatus for pricing a financial derivative, the derivative relating to an asset, a value of the asset being governed by a defined stochastic differential equation, a volatility term of the equation being identified using a random variable, and the apparatus comprising:
means for calculating 2N moments of the random variable, including a zeroth moment, wherein N is a predetermined natural number;
means for calculating N pairs of a weight and an abscissa, each weight-abscissa pair corresponding to a calculated pair of moments;
means for using the weight-abscissa pairs, a starting price of the asset, and the defined stochastic differential equation to define a series of N paths, wherein each path corresponds to one weight-abscissa pair, and each path can be used to determine a corresponding later price of the asset;
means for performing a weighted averaging of the determined later prices using the corresponding weights to determine an expected payoff value; and
means for pricing the derivative by using the expected payoff value.

16. The apparatus of claim 15, wherein the random variable has a normal probability distribution function, and wherein the calculated weight-abscissa pairs correspond to Gauss-Hermite parameters.

17. The apparatus of claim 15, wherein the derivative is selected from the group consisting of a stock option, a bond, a future, a mortgage-backed security, a credit risk calculation, and an insurance risk calculation.

18. The apparatus of claim 15, wherein the asset is selected from the group consisting of a stock price, an interest rate, a composite credit profile, and a composite insurance profile.

19. The apparatus of claim 15, wherein N is less than or equal to 12.

20. A storage medium for storing software for pricing a financial derivative, the derivative relating to an asset, a value of the asset being governed by a defined stochastic differential equation, a volatility term of the defined equation being identified by a random variable, and the software being computer-readable, wherein the software includes instructions for causing a computer to:
calculate 2N moments of the random variable, including a zeroth moment, wherein N is a predetermined natural number;
calculate N pairs of a weight and an abscissa, each weight-abscissa pair corresponding to a calculated pair of moments;
use the weight-abscissa pairs, a starting price of the asset, and the defined stochastic differential equation to respectively define a series of N paths, wherein each path corresponds to one weight-abscissa pair, and each path can be used to determine a corresponding later price of the asset;
perform a weighted averaging of the determined later prices using the corresponding weights to determine an expected payoff value; and
use the expected payoff value to price the derivative.

21. The storage medium of claim 20, wherein the random variable has a normal probability distribution function, and wherein the calculated weight-abscissa pairs correspond to Gauss-Hermite parameters.

22. The storage medium of claim 20, wherein the derivative is selected from the group consisting of a stock option, a bond, a future, a mortgage-backed security, a credit risk calculation, and an insurance risk calculation.

23. The storage medium of claim 20, wherein the asset is selected from the group consisting of a stock price, an interest rate, a composite credit profile, and a composite insurance profile.

24. The storage medium of claim 20, wherein N is less than or equal to 12.
